(19) United States
(12) Patent Application Publication
(10) Pub. No.: US 2026/0177670 A1
(43) Pub. Date: Jun. 25, 2026

(54) CONTROL METHOD, CONTROL CIRCUIT, AND CONTROL SYSTEM FOR LIDAR

(71) Applicant: TUDATONG (SUZHOU) CO., LTD., SUZHOU (CN)

(72) Inventors: Jun Yu, SUZHOU (CN); Anxiao Ye, SUZHOU (CN)

(73) Assignee: TUDATONG (SUZHOU) CO., LTD., SUZHOU, JS (CN)

(21) Appl. No.: 19/417,059

(22) Filed: Dec. 11, 2025

(30) Foreign Application Priority Data
Dec. 20, 2024 (CN) 202411893554.9

(51) Int. Cl. G01S 7/481; G01P 3/481; G01S 17/931

(52) U.S. Cl. CPC G01S 7/4817; G01P 3/481; G01S 17/931

(57) ABSTRACT

The present disclosure provides a method, a circuit, and a system applied to a LiDAR, and a computer-readable storage medium. The LiDAR includes a laser-emitting device for emitting laser light and a motor for driving an optical redirecting element to move. The method includes: acquiring first signals output by a plurality of sensors at a first time point; acquiring second signals output by the plurality of sensors at a second time point after the first time point; determining, in response to the second signals being different from the first signals, a first rotation direction of the motor based on a signal change from the first signals to the second signals; and determining, based on the determined first rotation direction of the motor, whether the laser-emitting device is controlled to stop emitting the laser light.

### TECHNICAL FIELD

The present disclosure relates to the technical field of lidars, and particularly to a control method, a control circuit, and a control system applied to a lidar, a computer device, a computer-readable storage medium, a computer program product, the lidar, and a vehicle system.

### BACKGROUND

Lidar is short for light detection and ranging system, and includes an emitting system, a receiving system, an information processing system, and a scanning system. Lidar uses laser light as a signal source, detects the distance to a target object by emitting and receiving the laser light, and generates three-dimensional structural information of the target object based on the reflected energy, reflected spectrum amplitude, frequency, and phase information from the surface of the target object.

A signal steering system in a lidar includes one or more optical redirecting elements (e.g., reflecting mirrors or lenses) which are driven by a motor and can direct optical pulses along different paths to enable the lidar to scan the surrounding environment. In some cases (for example, reverse rotation of a motor or back-and-forth swing of a rotor), if a laser-emitting device is not turned off in a timely manner, the optical pulses emitted from the laser-emitting device will repeatedly irradiate the same position or area for a long time. If this position or area includes the human eyes, the human eyes will be greatly injured.

The methods described in this section are not necessarily those that have been previously envisioned or adopted. Unless otherwise indicated, none of the methods described in this section should be assumed to be the prior art merely because they are included in this section. Similarly, unless otherwise indicated, the problems mentioned in this section should not be considered as having been recognized in any prior art.

### SUMMARY

The present disclosure is intended to solve at least one of the technical problems existing in the background. In view of this, an objective of the present disclosure is to provide a solution that can more accurately detect an operating state of a motor and control a laser-emitting device of a lidar, thereby enhancing human eye protection.

According to a first aspect of an embodiment of the present disclosure, there is provided a control method applied to a lidar. The lidar includes a laser-emitting device for emitting laser light and a motor for driving an optical redirecting element to move. The motor is provided with a plurality of sensors for detecting a rotational position of the motor. The control method includes: acquiring first signals output by a plurality of sensors at a first time point; acquiring second signals output by the plurality of sensors at a second time point after the first time point; determining, in response to the second signals being different from the first signals, a first rotation direction of the motor based on a signal change from the first signals to the second signals; and determining, based on the determined first rotation direction of the motor, whether the laser-emitting device is controlled to stop emitting the laser light.

According to a second aspect of an embodiment of the present disclosure, there is provided a control circuit applied to a lidar. The lidar includes a laser-emitting device for emitting laser light and a motor for driving an optical redirecting element to move. The motor is provided with a plurality of sensors for detecting a rotational position of the motor and outputting information of the position as a level signal. The control circuit includes a first circuit and a second circuit, where the first circuit is configured to generate a signal indicating a rotation direction of the motor, and the second circuit is configured to generate a signal indicating whether a rotational speed of the motor is lower than a preset rotational speed.

According to a third aspect of an embodiment of the present disclosure, there is provided a vehicle system applied to a lidar. The lidar includes a laser-emitting device for emitting laser light and a motor for driving an optical redirecting element to move. The motor is provided with a plurality of sensors for detecting a rotational position of the motor. The control system includes: a first module, configured to acquire first signals output by a plurality of sensors at a first time point; a second module, configured to acquire second signals output by the plurality of sensors at a second time point after the first time point; a third module, configured to determine, in response to the second signals being different from the first signals, a first rotation direction of the motor based on a signal change from the first signals to the second signals; and a fourth module, configured to determine, based on the determined first rotation direction of the motor, whether the laser-emitting device is controlled to stop emitting the laser light.

According to a fourth aspect of an embodiment of the present disclosure, there is provided a computer device, including: at least one processor; and at least one memory, having a computer program stored thereon, where the computer program, when executed by the at least one processor, causes the at least one processor to perform the method according to the first aspect above.

According to a fifth aspect of an embodiment of the present disclosure, there is provided a computer-readable storage medium, having a computer program stored thereon, where the computer program, when executed by a processor, causes the processor to perform the method according to the first aspect above.

According to a sixth aspect of an embodiment of the present disclosure, there is provided a computer program product, including a computer program, where the computer program, when executed by a processor, causes the processor to perform the method according to the first aspect above.

According to a seventh aspect of an embodiment of the present disclosure, there is provided a lidar, including: the control circuit according to the second aspect above, the control system according to the third aspect above, or the computer device according to the fourth aspect above.

According to an eighth aspect of an embodiment of the present disclosure, there is provided a vehicle system, including at least one lidar according to the seventh aspect above.

According to one or more embodiments of the present disclosure, there are provided a control method, a control circuit, and a control system applied to a lidar, a computer device, a computer-readable storage medium, a computer program product, and a vehicle system. Through the control method, the control circuit, the control system, the computer device, the computer-readable storage medium, the computer program product, and the vehicle system, the operating state of the motor can be detected, thereby improving the problem that the laser-emitting device of the lidar cannot be accurately controlled due to vibration of the lidar or back-and-forth swing of a rotor at a specific angle.

### BRIEF DESCRIPTION OF THE DRAWINGS

The drawings exemplarily illustrate embodiments and constitute part of the specification, and together with the textual description of the specification, serve to illustrate exemplary implementations of the embodiments. The embodiments shown are for illustrative purposes only and do not limit the scope of claims. In all the drawings, the same reference numerals refer to the same elements or similar but not necessarily identical elements.

FIG. 1 is a schematic flowchart illustrating a control method 10 for a lidar according to an embodiment of the present disclosure;

FIG. 2 is a schematic flowchart illustrating a control method 10 for a lidar according to some embodiments of the present disclosure;

FIG. 3 is a schematic flowchart illustrating a control method 10 for a lidar according to some embodiments of the present disclosure;

FIG. 4 is a schematic flowchart illustrating a control method 10 for a lidar according to some embodiments of the present disclosure;

FIG. 5 is a schematic flowchart illustrating step S800 in a control method 10 for a lidar according to some embodiments of the present disclosure;

FIG. 6 is a schematic diagram illustrating a control circuit 20 for a lidar according to an embodiment of the present disclosure; and

FIG. 7 is a schematic diagram illustrating a control system 900 for a lidar according to an embodiment of the present disclosure.

### DETAILED DESCRIPTION OF THE EMBODIMENTS

The present disclosure is further described in detail below in conjunction with the drawings and embodiments. It can be understood that the specific embodiments described herein are merely to illustrate the related invention, and are not intended to limit the invention. Additionally, it should be noted that for ease of description, only parts related to the related invention are shown in the drawings.

It should be noted that the embodiments of the present disclosure and the features in the embodiments may be combined with each other unless without conflict. Unless otherwise explicitly stated in the context, if the number of elements is not specifically limited, the element can be one or plural. In addition, the numbers of steps or functional modules used in the present disclosure are only used to identify each step or functional module, and are not used to limit the execution order of each step or the connection relationship between each functional module.

In the present disclosure, unless otherwise specified, the use of the terms “first”, “second”, etc. to describe various elements is not intended to define the positional relationship, temporal relationship, or importance relationship of these elements, and such terms are simply used to distinguish one element from another element. In some examples, the first element and the second element may refer to the same instance of the element, while in some cases, they may also refer to different instances based on contextual descriptions.

In the present disclosure, the terms used in the description of various described examples are for the purpose of describing specific examples only, and are not intended to be limiting. Unless otherwise explicitly stated in the context, if the number of elements is not specifically limited, the element can be one or plural. In addition, the term “and/or” used in the present disclosure encompasses any one and all possible combinations of the listed items.

In the technical field of lidars, the instantaneous power of optical pulses emitted from a laser-emitting device can reach hundreds of watts. To avoid injury to the human eyes due to prolonged exposure to the optical pulses, the number of pulses generated by a counting encoder within a certain period of time is typically used to determine whether a motor has stopped in the related art. If it is detected that the number of pulses within a certain period of time is zero, it is generally considered that the motor has stopped operating.

However, in some cases, even if the motor has stopped operating, the encoder may still generate pulse signals. For example, a rotor of the motor vibrates due to external force applied to the lidar, or the rotor swings back and forth at a specific angle after the motor stops due to improper gain parameter setting, load unbalance, or other reasons. At this time, since the pulse signals from the encoder can still be detected, the laser-emitting device of the lidar will continue to emit laser light, causing injury to the human eyes.

According to an embodiment of the present disclosure, there is provided a control method applied to a lidar. Through the control method, an operating state of a motor can be detected, thereby improving the problem that a laser-emitting device of the lidar cannot be accurately controlled due to vibration of the lidar or back-and-forth swing of a rotor at a specific angle.

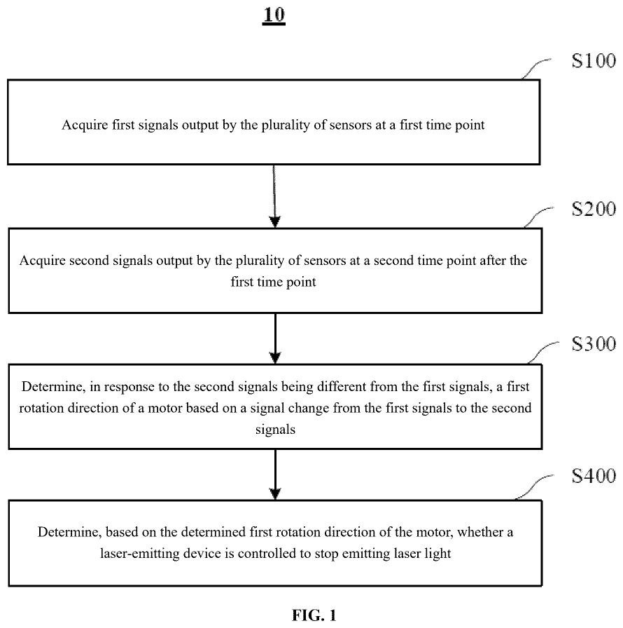

FIG. 1 is a schematic flowchart illustrating a control method 10 for a lidar according to an embodiment of the present disclosure. The control method 10 is applied to the lidar. The lidar according to the embodiment of the present disclosure may include a laser-emitting device for emitting laser light and a motor for driving an optical redirecting element to move, where the motor is provided with a plurality of sensors for detecting a rotational position of the motor. As shown in FIG. 1, the control method 10 for the lidar may include:
S100: acquiring first signals output by the plurality of sensors at a first time point;
S200: acquiring second signals output by the plurality of sensors at a second time point after the first time point;
S300: determining, in response to the second signals being different from the first signals, a first rotation direction of the motor based on a signal change from the first signals to the second signals; and
S400: determining, based on the determined first rotation direction of the motor, whether the laser-emitting device is controlled to stop emitting the laser light.

According to the embodiment of the present disclosure, the rotation direction of the motor can be determined based on the signal change from the first signals to the second signals. In this way, an operating state of the motor can be detected more accurately and the laser-emitting device of the lidar can be controlled, thereby enhancing human eye protection.

In some embodiments, the optical redirecting element includes an element for redirecting the laser light emitted by the laser-emitting device or a returned optical signal. For example, the element includes a rotating mirror in the lidar with the optical redirecting element, or other optical elements that steer an optical pulse or an optical signal by rotational motion. Herein, the rotating mirror is used as an example, and the motor drives the rotating mirror to rotate so as to achieve scanning in a horizontal direction.

In some embodiments, the sensors disposed on the motor may be Hall sensors. For example, three Hall sensors mounted on a rotor of the motor and arranged at intervals of an electrical angle of 120° may be used to detect a position of the rotor. It should be understood that other types or numbers of sensors may also be used. For example, photoelectric sensors or photoelectric encoders may be used; or the number of sensors may be six (for example, arranged at intervals of an electrical angle of 60°), which should not be construed as limiting. In some embodiments, the rotation direction of the motor may also be determined based on signals provided by sensors such as phase angle sensors and used for indicating a phase (including a phase sequence and a phase angle) of the motor.

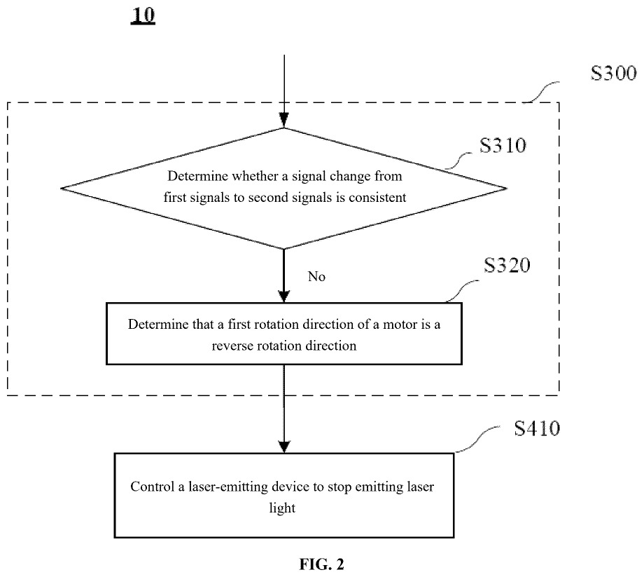

FIG. 2 is a schematic flowchart illustrating a control method 10 for a lidar according to some embodiments of the present disclosure.

In some embodiments, with reference to FIG. 2, in step S300, the determining a first rotation direction of the motor based on a signal change from the first signals to the second signals includes:
S310: determining whether the signal change from the first signals to the second signals is consistent with an expected signal change, where the expected signal change indicates that the motor rotates in a predetermined rotation direction; and S320: determining, in response to the signal change being inconsistent with the expected signal change, that the first rotation direction of the motor is a reverse rotation direction opposite to the predetermined rotation direction.

In some embodiments, the signals output by the plurality of sensors may be continuously sampled (for example, at a fixed frequency), and a time interval between adjacent sampling processes is typically much shorter than time required for the motor to complete one rotation. In this way, when the signals output by the plurality of sensors change, the changed output signals can be acquired in a timely manner. For example, the first signals output by the sensors at the first time point are acquired first, and then the second signals output by the sensors at the second time point are acquired. The second signals are compared with the previously acquired first signals. If the second signals are inconsistent with the first signals, the change from the first signals to the second signals is further determined, as detailed below. Due to a possibly high sampling frequency, in some cases, the signals acquired in the second sampling process may be the same as the first signals. In this case, the signals from the sensors may continue to be acquired at the frequency.

In some embodiments, when the motor rotor rotates in one direction, a sequence of levels output by the sensors is fixed. Three Hall sensors arranged at intervals of an electrical angle of 120° are used as an example. Every time the rotor rotates by an electrical angle of 60°, one of the Hall sensors changes its state and outputs a corresponding logic level (0 or 1). Therefore, whether the rotor rotates in the forward or reverse direction, a sequence of changes in level signals output by the sensors is fixed. Normal motor operation (i.e., forward rotation of the rotor) is used as an example. A sequence of the signals output by the sensors may be 101-100-110-010-011-001-101-100 . . . , and the signal change consistent with the sequence may be used as the “expected signal change”, indicating that the motor rotates in the predetermined rotation direction. Depending on actual requirements, the sequence of the changes in the signals output by the sensors during reverse rotation of the rotor (for example, “101-001-011-010-110-100-101-100 . . . ”) may also be used as the “expected signal change”.

When the first rotation direction of the motor is determined, according to the above embodiment, if the first signals acquired at the first time point are 101, and the second signals acquired at the second time point are 001, then the signal change from the first signals to the second signals (i.e., 101-001) is inconsistent with the expected signal change (i.e., 101-100). In this case, it can be determined that the first rotation direction is the reverse rotation direction. Reverse rotation of the motor means that the motor has stopped operating, and due to some reasons (for example, vibration of the lidar or the rotor being at a specific stop angle), the rotor swings back and forth, causing the sequence of the signals output by the sensors to be opposite to the expected signal change.

In some embodiments, with continued reference to FIG. 2, the process can proceed to step S410 of controlling, in response to the determined first rotation direction of the motor being the reverse rotation direction, the laser-emitting device to stop emitting the laser light.

Controlling the laser-emitting device to stop emitting the laser light upon detecting reverse rotation of the motor can improve the problem that the lidar cannot be controlled in a timely manner to stop emitting the laser light due to back-and-forth swing of the rotor.

In some embodiments, a duration for which the laser-emitting device stops emitting the laser light may also be set. For example, the laser-emitting device is enabled to stop emitting the laser light within a first preset time, thereby further improving safety.

In some cases, even if the first rotation direction of the motor is a forward rotation direction, the human eyes may be injured. For example, after the motor stops rotating, the rotor continues to rotate slowly due to inertia, causing the optical pulse to remain in the human eyes for a longer time. Alternatively, when the motor rotor swings back and forth, at the time sampling begins (i.e., the first time point), the rotor is exactly in a forward rotation state. In the above case, since a swing or rotational speed of the rotor is much lower than a rotational speed during normal operation, the human eyes may be injured due to prolonged exposure to the optical pulse. Therefore, it is necessary to consider the scenario where the motor rotates forward but at a low speed, which may cause injury to the human eyes.

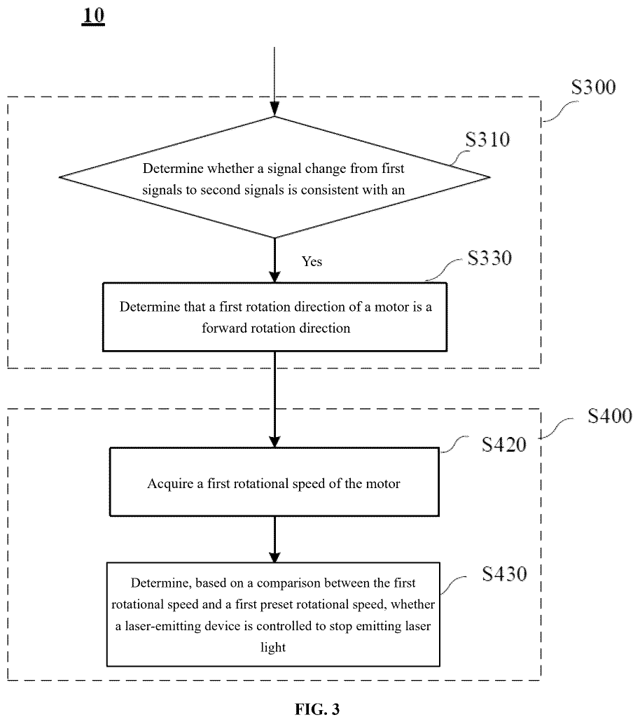

FIG. 3 is a schematic flowchart illustrating a control method 10 for a lidar according to some embodiments of the present disclosure.

In some embodiments, with reference to FIG. 3, step S300 may further include: S310: determining whether the signal change from the first signals to the second signals is consistent with an expected signal change, where the expected signal change indicates that the motor rotates in a predetermined rotation direction; and S330: determining, in response to the signal change being consistent with the expected signal change, that the first rotation direction of the motor is a forward rotation direction which is the same as the predetermined rotation direction.

When it is determined that the first rotation direction of the motor is the forward rotation direction, step S400 may include: S420: acquiring a first rotational speed of the motor; and S430: determining, based on a comparison between the first rotational speed and a first preset rotational speed, whether the laser-emitting device is controlled to stop emitting the laser light.

The first rotational speed of the motor may be determined by the sensors (for example, Hall sensors) for detecting the rotational position of the motor, or may be determined by other rotational speed detection devices, without any limitation herein.

In some embodiments, the first preset rotational speed may be set as a threshold for determining whether the detected first rotational speed may cause injury to the human eyes. When the first rotation direction of the motor is the forward rotation direction, whether the laser-emitting device is controlled to stop emitting the laser light is determined by determining whether the current rotational speed of the motor is lower than the preset threshold (i.e., the first preset rotational speed).

In some embodiments, when it is determined that the first rotational speed is lower than the first preset rotational speed, the laser-emitting device can be controlled to stop emitting the laser light.

By providing step of detecting the rotational speed of the motor, the possibility of the lidar causing injury to the human eyes can be further reduced. In some cases, step of detecting the rotational speed of the motor can more quickly determine whether the laser-emitting device is controlled to stop emitting the laser light, thereby shortening response time.

In some other cases, for example, in the event of motor failure, the rotor may maintain a high rotational speed and rotate in one direction (for example, reverse) for a period of time, and then rotate in another direction (for example, forward) for a period of time. Especially in the presence of signal interference, the rotor may repeatedly perform the above process. Therefore, it is also necessary to consider the problem that the laser-emitting device is turned on again within a very short time after being turned off, or is frequently turned on and off within a short time, resulting in injury to the human eyes due to repeated exposure to the optical pulse.

It should be understood that, although in some embodiments, whether the motor has stopped operating may be determined by detecting the rotation direction of the motor as described above to control the laser-emitting device to stop emitting the laser light, in some other embodiments, whether the motor has stopped operating may also be determined by other methods (for example, by measuring other physical parameters of the motor). For example, in some embodiments, whether the motor has stopped operating may be determined by measuring the rotational speed of the motor rotor; and in some other embodiments, whether the motor has stopped operating may also be determined by measuring the vibration intensity of the motor. When the vibration intensity of the motor is lower than a preset intensity threshold, it can be determined that the motor has stopped operating, and the laser-emitting device can be controlled to stop emitting the laser light.

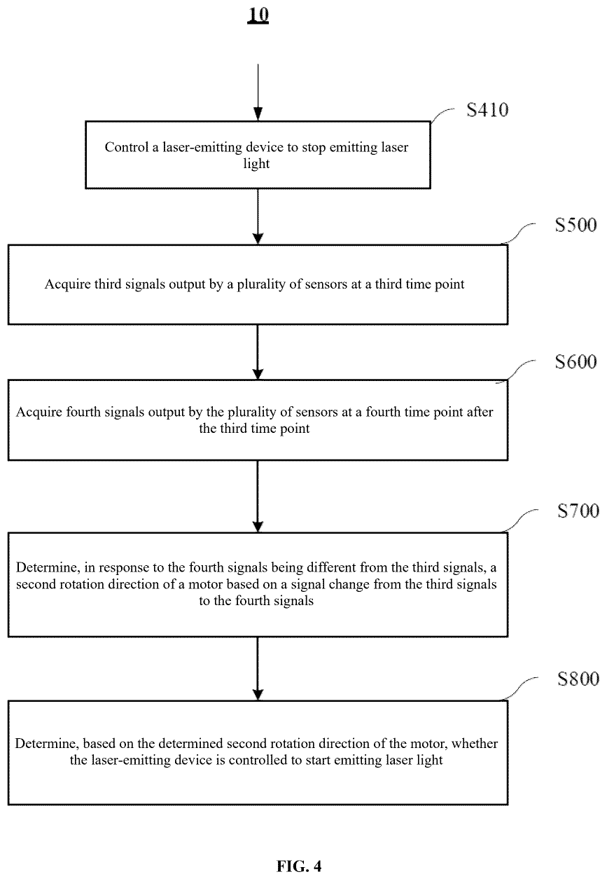

FIG. 4 is a schematic flowchart illustrating a control method 10 for a lidar according to some embodiments of the present disclosure.

In some embodiments, with reference to FIG. 4, after step S410 of controlling the laser-emitting device to stop emitting the laser light, signals output by the sensors at a next time point can continue to be acquired, i.e., the process continues to: step S500 of acquiring third signals output by the plurality of sensors at a third time point; and step S600 of acquiring fourth signals output by the plurality of sensors at a fourth time point after the third time point.

Next, the process can proceed to: step S700 of determining, in response to the fourth signals being different from the third signals, a second rotation direction of the motor based on a signal change from the third signals to the fourth signals; and step S800 of determining, based on the determined second rotation direction of the motor, whether the laser-emitting device is controlled to start emitting the laser light.

In some embodiments, a method similar to the method for determining the first rotation direction described above may be used to determine the second rotation direction of the motor based on the signal change from the third signals to the fourth signals, which will not be repeated herein.

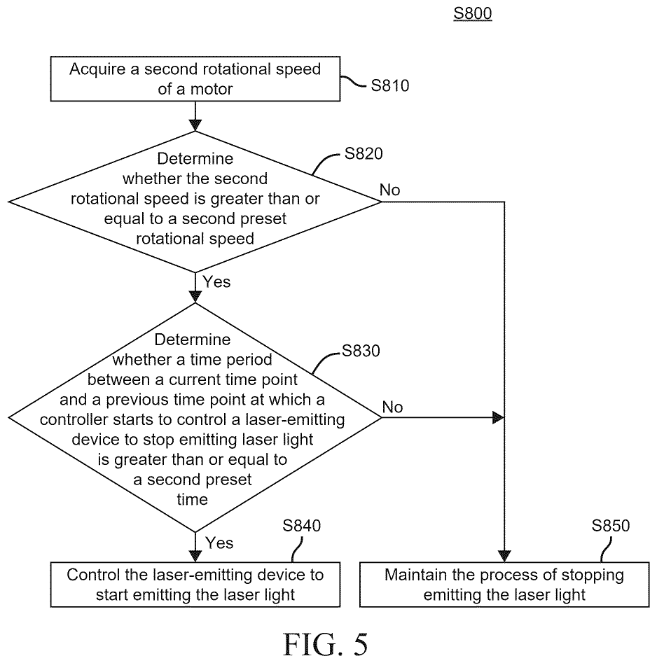

FIG. 5 is a schematic flowchart illustrating step S800 in a control method 10 for a lidar according to some embodiments of the present disclosure.

In some embodiments, when it is determined that the second rotation direction of the motor is a forward rotation direction, with reference to FIG. 5, step S800 of determining, based on the determined second rotation direction of the motor, whether the laser-emitting device is controlled to start emitting the laser light may include: step S810 of acquiring a second rotational speed of the motor; and step S820 of determining whether the second rotational speed is greater than or equal to a second preset rotational speed.

Similarly, the second rotational speed of the motor may be determined by the sensors (for example, Hall sensors) for detecting the rotational position of the motor, or may be determined by other rotational speed detection devices, without any limitation herein.

The second preset rotational speed may be set as a threshold for determining whether the detected second rotational speed may cause injury to the human eyes. In some embodiments, the first preset rotational speed and the second preset rotational speed may be the same value. In some embodiments, if the second rotational speed is lower than the second preset rotational speed, the process proceeds to step S850 of maintaining the state where the laser-emitting device stops emitting the laser light. In this case, since the second rotational speed has not reached the preset threshold, there is still a risk of injury to the human eyes if the laser-emitting device is controlled to start emitting the laser light. If the second rotational speed is greater than or equal to the second preset rotational speed, the process proceeds to step S830 of determining whether a time period between a current time point and a previous time point at which a controller starts to control the laser-emitting device to stop emitting the laser light is greater than a second preset time.

As mentioned above, repeatedly turning off and on the laser-emitting device within a short time may cause injury to the human eyes due to repeated exposure to the optical pulse. Therefore, in some embodiments of the present disclosure, it is necessary to further determine whether the time period between the current time point and the previous time point at which the controller starts to control the laser-emitting device to stop emitting the laser light is greater than the second preset time. If the time interval is greater than the second preset time, the process proceeds to step S840 of controlling the laser-emitting device to start emitting the laser light; otherwise, the process proceeds to step S850 of maintaining the state where the laser-emitting device stops emitting the laser light.

By setting the second preset time, the possibility of the laser-emitting device being turned on again within a very short time after being turned off or being repeatedly turned on and off within a short time can be reduced. In addition to enhancing human eye protection, it can also reduce adverse effects on the performance and life of the lidar.

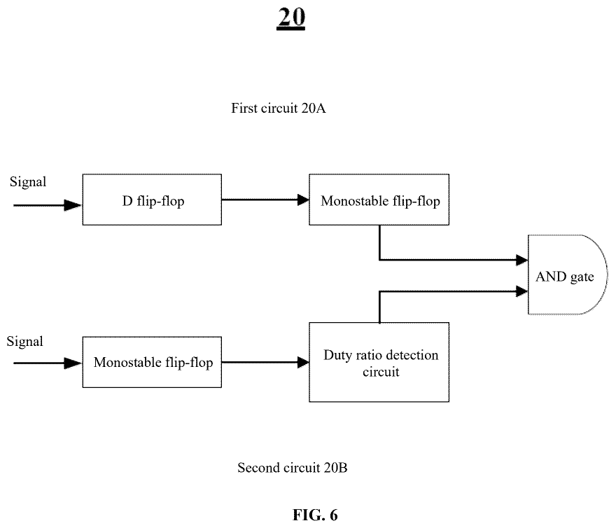

FIG. 6 is a schematic diagram illustrating a control circuit 20 for a lidar according to some embodiments of the present disclosure. The control circuit 20 includes a first circuit 20A and a second circuit 20B. The first circuit 20A is configured to generate a signal indicating a rotation direction of a motor, and the second circuit 20B is configured to generate a signal indicating whether a rotational speed of the motor is lower than a preset rotational speed.

In some embodiments, the first circuit 20A may include a monostable flip-flop and at least one of the following: a D flip-flop, a complex programmable logic device, or a field programmable gate array.

As an example, the first circuit 20A includes a D flip-flop and a monostable flip-flop, and sensors used are Hall sensors. An output of each Hall sensor may be connected to a data input terminal (a D terminal) of one D flip-flop, while a clock input terminal (a CP terminal) of the D flip-flop may receive a signal from another Hall sensor to achieve sequential storage of Hall signals. An output terminal (a Q terminal) of the D flip-flop may be connected to a trigger terminal of the monostable flip-flop. When a state of the D flip-flop changes, the monostable flip-flop receives a trigger pulse and outputs a short level pulse, indicating that the rotation direction of the motor has changed.

In some embodiments, the second circuit may include a monostable flip-flop and a duty ratio detection circuit. For example, when the sensors detect a change in the position of the motor rotor, the monostable flip-flop is triggered to generate a pulse. The pulse may be input as a PWM signal to the duty ratio detection circuit, which then determines whether the rotational speed of the motor is lower than a preset threshold based on a width of the pulse. If a duty ratio is higher than a set value (i.e., the pulse width of the monostable flip-flop is short, and the rotational speed is high), the duty ratio detection circuit outputs a high level; and if the duty ratio is lower than the set value (i.e., the pulse width of the monostable flip-flop is long, and the rotational speed is low), the duty ratio detection circuit outputs a low level, thereby indicating whether the rotational speed of the motor is lower than the preset rotational speed.

In some embodiments, the control circuit may further include a logic gate, such as an AND gate. A first input terminal of the AND gate may be used to receive the signal indicating the rotation direction of the motor, and a second input terminal thereof may be used to receive the signal indicating whether the rotational speed of the motor is lower than the preset rotational speed. An output terminal of the AND gate may serve as an output terminal of the control circuit and is used to output a control signal to control the laser-emitting device to start emitting laser light or to control the laser-emitting device to stop emitting the laser light.

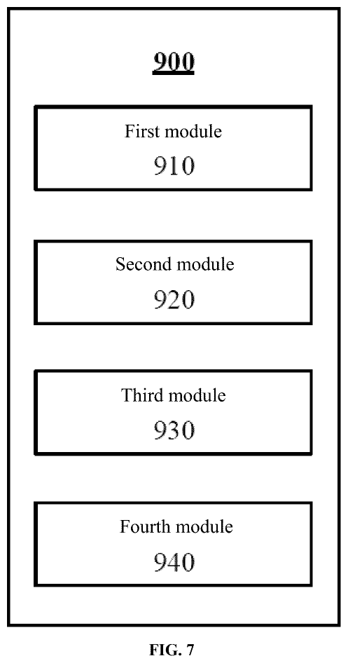

FIG. 7 is a schematic diagram illustrating a control system 900 for a lidar according to an embodiment of the present disclosure. The control system 900 may include a first module 910, a second module 920, a third module 930, and a fourth module 940. The first module 910 is configured to acquire first signals output by a plurality of sensors at a first time point. The second module 920 configured to acquire second signals output by the plurality of sensors at a second time point after the first time point. The third module 930 is configured to determine, in response to the second signals being different from the first signals, a first rotation direction of a motor based on a signal change from the first signals to the second signals. The fourth module 940 is configured to determine, based on the determined first rotation direction of the motor, whether the laser-emitting device is controlled to stop emitting laser light.

In this embodiment, for the specific implementations and technical effects of the control system 900 applied to the lidar and its corresponding functional modules 910-940, reference may be made to the relevant descriptions in the embodiments illustrated in FIG. 1 to FIG. 5, which will not be repeated herein.

According to the embodiment of the present disclosure, the process described above with reference to the flowchart may be implemented as a computer device. The computer device may include a processing apparatus (e.g., a central processing unit, a graphics processing unit, or the like), which can perform various appropriate actions and processing based on a program stored in a read-only memory (ROM) or a program loaded from a storage apparatus to a random access memory (RAM).

According to the embodiment of the present disclosure, the process described with reference to the flowchart 1 may be implemented as a computer software program. For example, an embodiment of the present disclosure provides a computer-readable storage medium, having a computer program stored thereon, where the computer program includes program codes for performing the method 10 shown in FIG. 1. When the computer program is executed by the processing apparatus, the above-mentioned functions defined in the apparatus in the embodiment of the present disclosure are implemented.

It should be noted that the computer-readable storage medium in the embodiment of the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination thereof. A more specific example of the computer-readable storage medium may include, but is not limited to, an electrical connection with one or more wires, a portable computer disk, a hard disk, a random access memory (RAM), a read-only memory (ROM), an erasable programmable read-only memory (EPROM or flash), an optical fiber, a portable compact disk read-only memory (CD-ROM), an optical storage device, a magnetic storage device, or any proper combination of thereof. In the embodiment of the present disclosure, the computer-readable storage medium may be any tangible medium including or storing a program that may be used by an instruction execution system, apparatus, or device, or be used in combination with an instruction execution system, apparatus, or device. In the embodiment of the present disclosure, the computer-readable signal medium may include a data signal propagated in a baseband or propagated as a part of a carrier, where the data signal carries computer-readable program code. Such a propagated data signal may be in a variety of forms, including but not limited to an electromagnetic signal, an optical signal, or any suitable combination thereof. The computer-readable signal medium may alternatively be any computer-readable medium other than the computer-readable storage medium. The computer-readable signal medium may send, propagate, or transmit the program used by the instruction execution system, apparatus, or device, or used in combination with the instruction execution system, apparatus, or device. The program codes included in the computer-readable medium may be transmitted by using any suitable medium, including but not limited to an electric wire, an optical cable, radio frequency (RF), or any suitable combination thereof.

The computer-readable medium may be included in the computer device, or exist alone and be not assembled in the computer device. The computer-readable medium carries one or more programs, which, when executed by the computer device, cause the computer device to: acquire first signals output by a plurality of sensors at a first time point; acquire second signals output by the sensors at a second time point after the first time point; determine, in response to the second signals being different from the first signals, a first rotation direction of a motor based on a signal change from the first signals to the second signals; and determine, based on the determined first rotation direction of the motor, whether the laser-emitting device is controlled to stop emitting laser light.

According to another aspect of the present disclosure, there is provided a computer program product, including a computer program, which, when executed by a processor, causes the processor to perform the control method 10 according to any of the above embodiments.

Computer program codes for performing the operations of the embodiment of the present disclosure may be written in one or more programming languages, or a combination thereof. The programming languages include an object-oriented programming language, such as Java, Smalltalk, and C++, and also include a conventional procedural programming language, such as a “C” language or a similar programming language. The program codes can be executed entirely on a user computer, partially executed on the user computer, executed as a separate software package, partially executed on the user computer and partially executed on a remote computer, or entirely executed on the remote computer or a server. When a remote computer is involved, the remote computer can be connected to a user computer by using any type of network, including a local area network (LAN) or a wide area network (WAN) or can be connected to an external computer (e.g., connected by an Internet service provider through the Internet).

According to another aspect of the present disclosure, there is provided a lidar. The lidar may include the control circuit 20, the control system 900, or the computer device according to any of the above embodiments. In some embodiments, the lidar according to the embodiment of the present disclosure may include the control circuit 20 and the control system 900 according to any of the above embodiments, to provide redundancy for a higher possibility of human eye protection.

According to another aspect of the present disclosure, there is provided a vehicle system, including the lidar in the above aspect.

Vehicles include, but are not limited to, vehicles, unmanned aerial vehicles, ships, etc., and their application scenarios include, but are not limited to, roadside detection devices, wharf monitors, road junction monitors, factories, and other systems with a plurality of sensors.

The flowcharts and block diagrams in the accompanying drawings show the system architectures, functions, and operations possibly implemented by the methods, devices, and computer program products according to the various embodiments of the present disclosure. In this regard, each block in the flowcharts or block diagrams may represent a module, a program segment, or a part of a code, and the module, the program segment, or the part of the code includes one or more executable instructions for implementing a specified logical function. It should also be noted that, in some alternative implementations, functions marked in the blocks may also occur in a sequence different from that marked in the accompanying drawings. For example, two consecutive blocks may be actually executed substantially in parallel, or sometimes may be executed in a reverse order, depending on a function related. It should also be noted that each box in the block diagram and/or flowchart, and a combination of the boxes in the block diagram and/or flowchart can be implemented by a dedicated hardware-based system that performs a prescribed function or operation, or by a combination of specialized hardware and computer instructions.

Units described in the embodiments of the present disclosure may be implemented using software or hardware. The described units may also be disposed in a processor, for example, they may be described as a processor including a first module, a second module, a third module, and a fourth module. Names of these modules do not limit the modules themselves in a certain case.

The following describes some exemplary solutions of the present disclosure.

Solution 1. A control method applied to a lidar, the lidar including a laser-emitting device for emitting laser light and a motor for driving an optical redirecting element to move, the motor being provided with a plurality of sensors for detecting a rotational position of the motor, and the control method including:
acquiring first signals output by the plurality of sensors at a first time point;
acquiring second signals output by the plurality of sensors at a second time point after the first time point;
determining, in response to the second signals being different from the first signals, a first rotation direction of the motor based on a signal change from the first signals to the second signals; and
determining, based on the determined first rotation direction of the motor, whether the laser-emitting device is controlled to stop emitting the laser light.

Solution 2. The control method according to Solution 1, where the determining a first rotation direction of the motor based on a signal change from the first signals to the second signals includes:
determining whether the signal change from the first signals to the second signals is consistent with an expected signal change, where the expected signal change indicates that the motor rotates in a predetermined rotation direction; and
determining, in response to the signal change being inconsistent with the expected signal change, that the first rotation direction of the motor is a reverse rotation direction opposite to the predetermined rotation direction.

Solution 3. The control method according to Solution 2, where the determining, based on the determined first rotation direction of the motor, whether the laser-emitting device is controlled to stop emitting the laser light includes:
controlling, in response to the determined first rotation direction of the motor being the reverse rotation direction, the laser-emitting device to stop emitting the laser light.

Solution 4. The control method according to Solution 3, further including:
controlling a duration for which the laser-emitting device stops emitting the laser light to be a first preset time.

Solution 5. The control method according to any one of Solutions 1 to 4, where the determining a first rotation direction of the motor based on a signal change from the first signals to the second signals includes:
determining whether the signal change from the first signals to the second signals is consistent with an expected signal change, where the expected signal change indicates that the motor rotates in a predetermined rotation direction; and
determining, in response to the signal change being consistent with the expected signal change, that the first rotation direction of the motor is a forward rotation direction which is the same as the predetermined rotation direction.

Solution 6. The control method according to Solution 5, where the determining, based on the determined first rotation direction of the motor, whether the laser-emitting device is controlled to stop emitting the laser light includes:
acquiring, in response to the determined first rotation direction of the motor being the forward rotation direction, a first rotational speed of the motor; and
determining, based on a comparison between the first rotational speed and a first preset rotational speed, whether the laser-emitting device is controlled to stop emitting the laser light.

Solution 7. The control method according to Solution 6, where the determining, based on a comparison between the first rotational speed and a first preset rotational speed, whether the laser-emitting device is controlled to stop emitting the laser light includes:
controlling, in response to the first rotational speed being lower than the first preset rotational speed, the laser-emitting device to stop emitting the laser light.

Solution 8. The control method according to Solution 3 or 7, further including:
acquiring third signals output by the plurality of sensors at a third time point;
acquiring fourth signals output by the plurality of sensors at a fourth time point after the third time point;
determining, in response to the fourth signals being different from the third signals, a second rotation direction of the motor based on a signal change from the third signals to the fourth signals; and
determining, based on the determined second rotation direction of the motor, whether the laser-emitting device is controlled to start emitting the laser light.

Solution 9. The control method according to Solution 8, where the determining a second rotation direction of the motor based on a signal change from the third signals to the fourth signals includes:
determining whether the signal change from the third signals to the fourth signals is consistent with the expected signal change; and
determining, in response to the signal change being consistent with the expected signal change, that the second rotation direction of the motor is a forward rotation direction.

Solution 10. The control method according to Solution 9, where the determining, based on the determined second rotation direction of the motor, whether the laser-emitting device is controlled to start emitting the laser light includes:
acquiring, in response to the determined second rotation direction of the motor being the forward rotation direction, a second rotational speed of the motor; and
determining, based on a comparison between the second rotational speed and a second preset rotational speed, whether the laser-emitting device is controlled to start emitting the laser light.

Solution 11. The control method according to Solution 10, where the determining, based on a comparison between the second rotational speed and a second preset rotational speed, whether the laser-emitting device is controlled to start emitting the laser light includes:
determining, in response to the second rotational speed being greater than or equal to the second preset rotational speed, whether a time period between a current time point and a previous time point at which the controller starts to control the laser-emitting device to stop emitting the laser light is greater than a second preset time; and
controlling, in response to determining that the time period between the current time point and the previous time point at which the controller starts to control the laser-emitting device to stop emitting the laser light is greater than or equal to the second preset time, the laser-emitting device to start emitting the laser light.

Solution 12. A control circuit applied to a lidar, the lidar including a laser-emitting device for emitting laser light and a motor for driving an optical redirecting element to move, the motor being provided with a plurality of sensors for detecting a rotational position of the motor and outputting information of the position as a level signal, and the control circuit including a first circuit and a second circuit, where
the first circuit is configured to generate a signal indicating a rotation direction of the motor; and
the second circuit is configured to generate a signal indicating whether a rotational speed of the motor is lower than a preset rotational speed.

Solution 13. The control circuit according to Solution 12, where the first circuit includes a monostable flip-flop and at least one of the following: a D flip-flop, a complex programmable logic device, or a field programmable gate array.

Solution 14. The control circuit according to Solution 12 or 13, where the second circuit includes:
a monostable flip-flop, configured to generate a pulse signal as signal outputs of the plurality of sensors change; and a duty ratio detection circuit, configured to receive the pulse signal and generate, based on a duty ratio of a width of the pulse signal, the signal indicating whether the rotational speed of the motor is lower than the preset rotational speed.

Solution 15. The control circuit according to any one of Solutions 12 to 14, where the plurality of sensors include Hall sensors.

Solution 16. A control system applied to a lidar, the lidar including a laser-emitting device for emitting laser light and a motor for driving an optical redirecting element to move, the motor being provided with a plurality of sensors for detecting a rotational position of the motor, and the control system including:
a first module, configured to acquire first signals output by the plurality of sensors at a first time point;
a second module, configured to acquire second signals different from the first signals and output by the plurality of sensors at a second time point after the first time point;
a third module, configured to determine a first rotation direction of the motor based on a signal change from the first signals to the second signals; and
a fourth module, configured to determine, based on the determined first rotation direction of the motor, whether the laser-emitting device is controlled to stop emitting the laser light.

Solution 17. A computer device, including:
at least one processor; and
at least one memory, having a computer program stored thereon,
where the computer program, when executed by the at least one processor, causes the at least one processor to perform the method according to any one of Solutions 1 to 11.

Solution 18. A computer-readable storage medium, having a computer program stored thereon, where the computer program, when executed by a processor, causes the processor to perform the method according to any one of Solutions 1 to 11.

Solution 19. A computer program product, including a computer program, where the computer program, when executed by a processor, causes the processor to perform the method according to any one of Solutions 1 to 11.

Solution 20. A lidar, including:
the control circuit according to any one of Solutions 12 to 15, the control system according to Solution 16, or the computer device according to Solution 17.

Solution 21. A vehicle system, including at least one lidar according to Solution 20.

The above descriptions are only preferred embodiments of the present disclosure and explanations of the technical principles applied. Those skilled in the art should understand that the scope of the invention involved in the embodiments of the present disclosure is not limited to the technical solutions formed by specific combinations of the above technical features, and should also cover other technical solutions formed by any combinations of the above technical features or their equivalent features without departing from the above inventive concept, for example, technical solutions formed by mutually replacing the above features with (but not limited to) the technical features with similar functions disclosed in the embodiments of the present disclosure.

1-21. (canceled)

22. A method for a light detection and ranging (LiDAR) system, the method comprising:
acquiring first signals output by a plurality of sensors at a first time point, the plurality of sensors being configured to detect a rotational position of a motor for driving an optical redirecting element;
acquiring second signals output by the plurality of sensors at a second time point after the first time point;
determining, in response to the second signals being different from the first signals, a first rotation direction of the motor based on a signal change from the first signals to the second signals; and
determining, based on the determined first rotation direction of the motor, whether a laser-emitting device of the LiDAR system is controlled to stop emitting the laser light.

23. The method according to claim 22, wherein the determining a first rotation direction of the motor based on a signal change from the first signals to the second signals comprises:
determining whether the signal change from the first signals to the second signals is consistent with an expected signal change, wherein the expected signal change indicates that the motor rotates in a predetermined rotation direction; and
determining, in response to the signal change being inconsistent with the expected signal change, that the first rotation direction of the motor is a reverse rotation direction opposite to the predetermined rotation direction.

24. The method according to claim 23, wherein the determining, based on the determined first rotation direction of the motor, whether the laser-emitting device is controlled to stop emitting the laser light comprises:
controlling, in response to the determined first rotation direction of the motor being the reverse rotation direction, the laser-emitting device to stop emitting the laser light.

25. The method according to claim 24, further comprising:
controlling a duration for which the laser-emitting device stops emitting the laser light to be a first preset time.

26. The method according to claim 22, wherein the determining a first rotation direction of the motor based on a signal change from the first signals to the second signals comprises:
determining whether the signal change from the first signals to the second signals is consistent with an expected signal change, wherein the expected signal change indicates that the motor rotates in a predetermined rotation direction; and
determining, in response to the signal change being consistent with the expected signal change, that the first rotation direction of the motor is a forward rotation direction which is the same as the predetermined rotation direction.

27. The method according to claim 26, wherein the determining, based on the determined first rotation direction of the motor, whether the laser-emitting device is controlled to stop emitting the laser light comprises:
acquiring, in response to the determined first rotation direction of the motor being the forward rotation direction, a first rotational speed of the motor; and
determining, based on a comparison between the first rotational speed and a first preset rotational speed, whether the laser-emitting device is controlled to stop emitting the laser light.

28. The method according to claim 27, wherein the determining, based on a comparison between the first rotational speed and a first preset rotational speed, whether the laser-emitting device is controlled to stop emitting the laser light comprises:
controlling, in response to the first rotational speed being lower than the first preset rotational speed, the laser-emitting device to stop emitting the laser light.

29. The method according to claim 24, further comprising:
acquiring third signals output by the plurality of sensors at a third time point;
acquiring fourth signals output by the plurality of sensors at a fourth time point after the third time point;
determining, in response to the fourth signals being different from the third signals, a second rotation direction of the motor based on a signal change from the third signals to the fourth signals; and
determining, based on the determined second rotation direction of the motor, whether the laser-emitting device is controlled to start emitting the laser light.

30. The method according to claim 29, wherein the determining a second rotation direction of the motor based on a signal change from the third signals to the fourth signals comprises:
determining whether the signal change from the third signals to the fourth signals is consistent with the expected signal change; and
determining, in response to the signal change being consistent with the expected signal change, that the second rotation direction of the motor is a forward rotation direction.

31. The method according to claim 30, wherein the determining, based on the determined second rotation direction of the motor, whether the laser-emitting device is controlled to start emitting the laser light comprises:
acquiring, in response to the determined second rotation direction of the motor being the forward rotation direction, a second rotational speed of the motor; and
determining, based on a comparison between the second rotational speed and a second preset rotational speed, whether the laser-emitting device is controlled to start emitting the laser light.

32. The method according to claim 31, wherein the determining, based on a comparison between the second rotational speed and a second preset rotational speed, whether the laser-emitting device is controlled to start emitting the laser light comprises:
determining, in response to the second rotational speed being greater than or equal to the second preset rotational speed, whether a time period between a current time point and a previous time point at which the controller starts to control the laser-emitting device to stop emitting the laser light is greater than a second preset time; and
controlling, in response to determining that the time period is greater than or equal to the second preset time, the laser-emitting device to start emitting the laser light.

33. A circuit for a light detection and ranging (LiDAR) system, the circuit comprising:
a first circuit configured to generate a signal indicating a rotation direction of a motor for driving an optical redirecting element to move, the motor being provided with a plurality of sensors for detecting a rotational position of the motor and outputting information of the position as a level signal; and
a second circuit configured to generate a signal indicating whether a rotational speed of the motor is lower than a preset rotational speed.

34. The circuit according to claim 33, wherein the first circuit comprises a monostable flip-flop and at least one of the following: a D flip-flop, a complex programmable logic device, or a field programmable gate array.

35. The circuit according to claim 33, wherein the second circuit comprises:
a monostable flip-flop, configured to generate a pulse signal as signal outputs of the plurality of sensors change; and
a duty ratio detection circuit, configured to receive the pulse signal and generate, based on a duty ratio of a width of the pulse signal, the signal indicating whether the rotational speed of the motor is lower than the preset rotational speed.

36. The circuit according to claim 33, wherein the plurality of sensors comprises Hall sensors.

37. Alight detection and ranging (LiDAR) system, comprising:
a laser-emitting device configured to emit laser light;
a motor configured to drive an optical redirecting element to move, the motor being provided with a plurality of sensors for detecting a rotational position of the motor; and
one or more processors and one or more non-transitory memory storing computer-readable instructions that, when executed by one or more processors, cause the one or more processors to perform the steps of:
acquiring first signals output by the plurality of sensors at a first time point;
acquiring second signals output by the plurality of sensors at a second time point after the first time point;
determining, in response to the second signals being different from the first signals, a first rotation direction of the motor based on a signal change from the first signals to the second signals; and
determining, based on the determined first rotation direction of the motor, whether the laser-emitting device is controlled to stop emitting the laser light.

38. Alight detection and ranging (LiDAR) system, comprising:
a laser-emitting device configured to emit laser light;
a motor configured to driving an optical redirecting element to move, the motor being provided with a plurality of sensors for detecting a rotational position of the motor; and
a circuit, the circuit comprising:
a first circuit configured to generate a signal indicating a rotation direction of a motor for driving an optical redirecting element to move, the motor being provided with a plurality of sensors for detecting a rotational position of the motor and outputting information of the position as a level signal; and
a second circuit configured to generate a signal indicating whether a rotational speed of the motor is lower than a preset rotational speed.
